(19) United States
(12) Patent Application Publication
(10) Pub. No.: US 2023/0067756 A1
(43) Pub. Date: Mar. 2, 2023

(54) USING MACHINE LEARNING FOR SECURITY ANOMALY DETECTION AND USER EXPERIENCE INFERENCE

(71) Applicant: AT&T Intellectual Property I, L.P., Atlanta, GA (US)

(72) Inventor: Wei Wang, Harrison, NJ (US)

(21) Appl. No.: 17/465,028

(22) Filed: Sep. 2, 2021

(51) Int. Cl. H04L 12/24; H04L 12/46; G06Q 30/02

(52) U.S. Cl. CPC H04L 41/5009; H04L 41/0604; H04L 12/4641; G06Q 30/0203

(57) ABSTRACT

The system may obtain log data and other device/statistical information and automatically identify a normal user experience, positive user experience, negative user experience, or the like. For the negative user experience, different groups of anomalies can be further identified as different types of negative user experiences. Such a system can initiate more targeted user experience study, identify software bugs, configuration issues, or security risks.

### BACKGROUND

Gaining insights of user experience about an application or a service may be difficult and expensive, especially at a large scale. For example, evaluating virtual private network experience for work-from-home time periods for thousands of employees might be time-consuming. Timely analysis of user experience for security or other software features may help improve the service and increase adoption.

This background information is provided to reveal information believed by the applicant to be of possible relevance. No admission is necessarily intended, nor should be construed, that any of the preceding information constitutes prior art.

### SUMMARY

The disclosed method may be used to test software, detect security anomalies, detect software bugs, detect faulty design process, or enhance customer satisfaction. In an example, an apparatus may include a processor and a memory coupled with the processor that effectuates operations. The operations may include identifying a plurality of state flows for a software service, wherein the plurality of state flows comprises a first state flow and a second state flow; identifying a plurality of sessions for the software service, wherein the plurality of sessions comprise a first group of sessions that executed the first state flow and a second group of sessions that executed the second state flow; receiving statistical information regarding the plurality of state flows and the plurality of sessions for the software service; sending, based on the statistical information, an indication that the second state flow is likely causing a negative user experience; and sending an alert to a user profile associated with a session of the second group of sessions, wherein the alert comprises a questionnaire about the user experience of the software service.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrates an exemplary system to dynamically assessing user experience and security anomalies.

FIG. 2A illustrates an exemplary VPN software service represented as a graph.

FIG. 2B illustrates an exemplary VPN software service represented as a subset of a graph.

FIG. 2C illustrates an exemplary VPN software service represented as a subset of a graph.

FIG. 2D illustrates an exemplary VPN software service represented as a subset of a graph.

FIG. 3 illustrates an exemplary method for dynamically assessing user experience and security anomalies.

FIG. 4 illustrates an exemplary method for dynamically assessing user experience and security anomalies.

FIG. 5 illustrates a schematic of an exemplary network device.

FIG. 6 illustrates an exemplary communication system that provides wireless telecommunication services over wireless communication networks.

### DETAILED DESCRIPTION

There are consultant companies that sell services such as providing questionnaire services to summarize user experience of software, but the services may be time consuming and expensive. The process of determining user experience may be enhanced in a more dynamic, targeted, and automated way be considering software services log data associated with the enterprise network or the public cloud and using machine learning or artificial intelligence on these log files. In addition, the survey method may be enhanced by providing targeted questions generated by machine learned algorithms that process historical information to targeted group of users. The disclosed system may obtain log data and other device/statistical information and automatically identify a normal user experience, positive user experience, negative user experience, or the like. For the abnormal user experience (e.g., negative user experience), different groups of anomalies can be further identified as different types of negative user experiences. Such negative user experience may include dropping at a certain step during a session login, or staying in a loop between two steps and never moving forward to complete a session login.

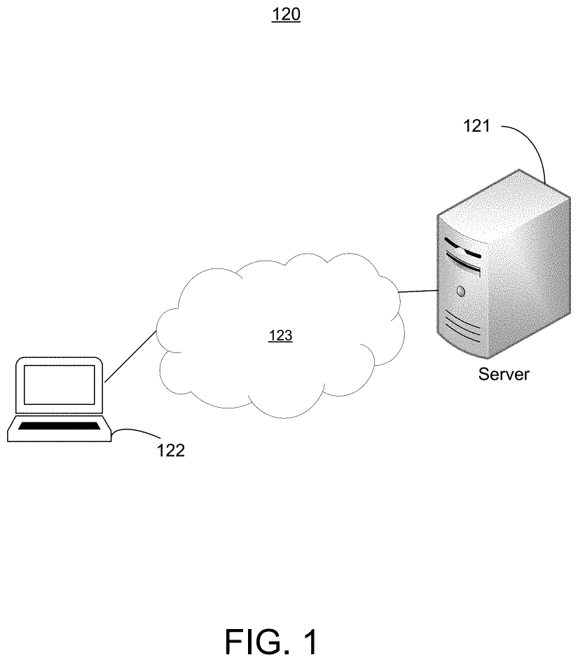

FIG. 1 illustrates an exemplary system to dynamically assess user experience and security anomalies, among other things. System 120 may include network 123, which may be used to connect devices, such as device 122 (e.g., a laptop or other computing device) and device 121 (e.g., a server or other computing device). Device 122 may be an end user device, such as a laptop, desktop, mobile device, or any other computing device. Device 121, in use cases disclosed herein, may be a server that is used to implement software services for device 121, such as virtual private network services. The devices of system 120, such as device 121 and device 122, may be communicatively connected with each other and network 123. Device 121 may be used for several different software services, such as virtual private network (VPN) services, firewall services, or domain name system services, among others.

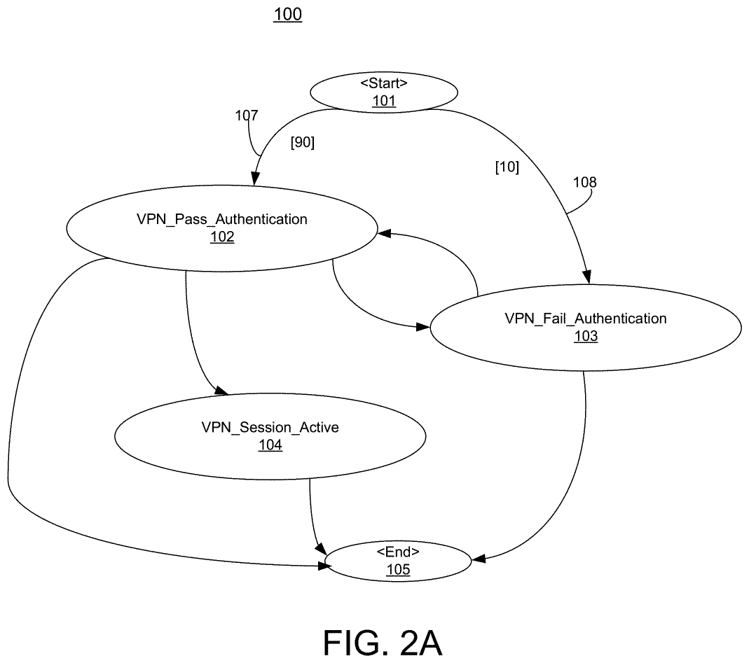

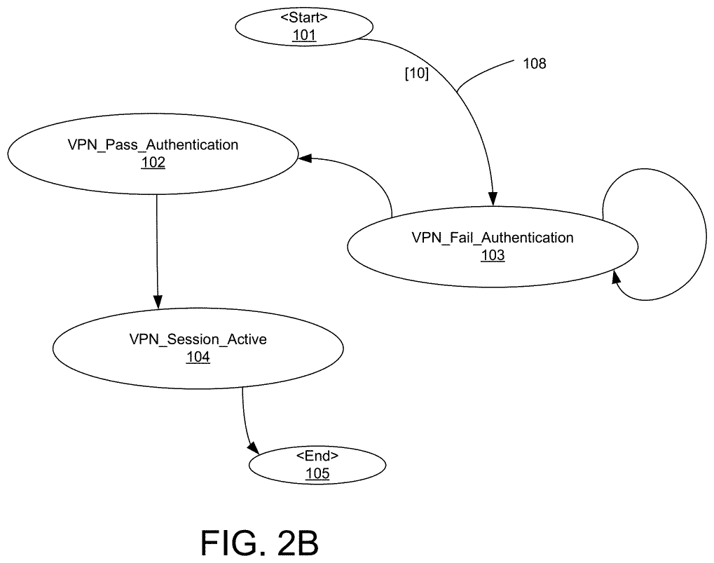

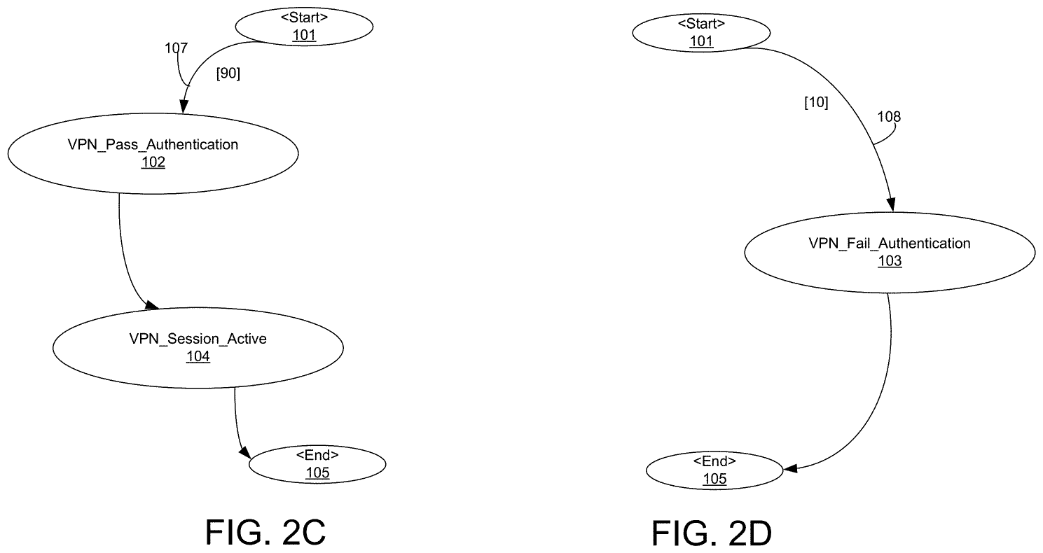

FIG. 2A illustrates an exemplary VPN software service represented as a graph: states are nodes and state transition are edges. Most applications, when engaged with user devices, may be defined as a process made of a sequence of application triggered events over time. For example, at the application level, to establish a VPN session, a user device has to first use the RSA token application, enter a personal identification number (PIN) code to generate a one-time code (OTC), then enter the OTC in the VPN application. The VPN application then verifies the code, if the user is authorized to use this VPN service, the VPN client will pick a VPN server to connect the user device with and finishes up the VPN connection establishment. Finally, a VPN session terminates by a user click or time-out. Errors can occur, such as a user failing authentication. A simplified version of some of the steps of the process can be represented as a graph shown in FIG. 2A-FIG. 2D, with each state is an oval node. There may be a weight on an edge that is the frequency (e.g., probability) of transiting from one state to another.

FIG. 2A illustrates a graph that shows multiple flows for executing the VPN software service. The graph includes multiple nodes, such as start node 101, end node 105, VPN_Pass_Authentication node 102, VPN_Failed_Attempt node 103, or VPN_Session_Active node 104. In addition, there are transitions, throughout the graph, such transition 107 or transition 108, among others. As disclosed in more detail herein, data logs, device information, or statistical information may be kept regarding the state flows and associated sessions that may execute the state flows. In an example, as shown in FIG. 2A, there may be a total of 100 sessions that were executed. Noted in FIG. 2A is a count of how many sessions went through each transition, such as 90 sessions for transition 107 or 10 sessions for transition 108. Graph 100 may include some or all of the states and state-transitions for the software service. FIG. 2B-FIG. 2D illustrate exemplary subsets of the states and state transitions of graph 100 that may be executed by one or more sessions.

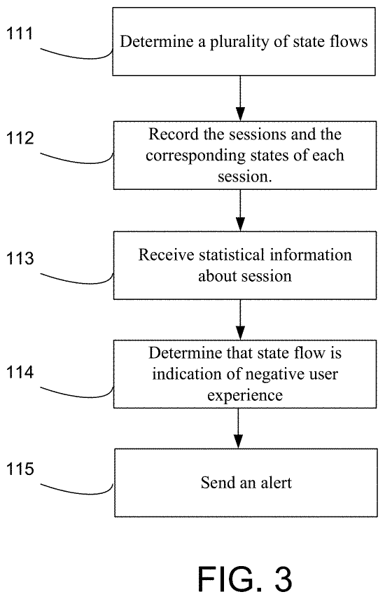

FIG. 3 illustrates an exemplary method for dynamically assessing user experience and security anomalies. At step 111, device 121 may determine a plurality of state flows for a software service (e.g., a VPN service) that may be executed during the performance of the service. As shown in FIG. 2A, there are several different possible states and transitions during the execution of a service during a session. At step 112, device 121 may record (e.g., in data logs) the sessions and the corresponding states of each session. Device 121 may dynamically build an overall state flow which may represent the complete set of possible states and achievable transitions among them (e.g., FIG. 2A) and subsets of the overall state flow which may represent states and transitions for individual users (e.g., FIG. 2B-FIG. 2D). The subset state flows may be placed into categories, such as negative user experience, positive user experience, undetermined user experience, or the like. A positive user experience can be identified in different ways, such as directly by domain/application experts or indirectly by the majority rule as majority of users will have similar state flows. A negative user experience or anomaly may include: (1) stuck in one step for a threshold period (e.g., 50 ms), (2) jump between multiple steps and never go to the goal state (e.g., VPN_Session_Active state node 104), (3) early stop step where it never reaches the goal state, (4) skip required steps, or (5) threshold delay (e.g., 60 seconds or more) that is considered unacceptable from start node 101 to end node 105.

With continued reference to FIG. 3, at step 113, information (e.g., data logs or statistical or device information) may be received regarding the sessions and the corresponding state flows. The information may be associated with state transitions, state nodes, or an overall state flow and may include delay during one or more sessions, latency during one or more sessions, packet loss during one or more sessions, errors during one or more sessions, bandwidth usage during one or more sessions, number of sessions executing a state flow, type of devices, device identifiers, operating systems for devices, or dates or times a state flow were created or used (which may be important as new devices, operating systems, or the like are introduced or discontinued), among other things.

At step 114, based on the device or statistical information, there may be a determination that execution of a state flow may be an indicator of a negative user experience. At step 115, in response to the indication of step 114, an alert may be sent to a contact of a user profile associated with a session that executed the first state flow of step 114. The alert may be a questionnaire to the user or other personnel regarding the session. The questionnaire may include targeted questions as indicated by the data analysis, such as “did you experience a session login issue with a long wait time of 2 minutes on Monday around 2 pm? If yes, do you have any profile changes shortly before that?”. The alert may provide an indication of device changes that may have contributed to the negative user experience. The system may also use the fact that multiple users showing the same anomalies have the same recent change may indicate that the cause of the anomaly is due to that change. The questionnaire information may be used with the device and statistical information in order to ultimately categorize the state flows and dynamically assess user experience or security anomalies.

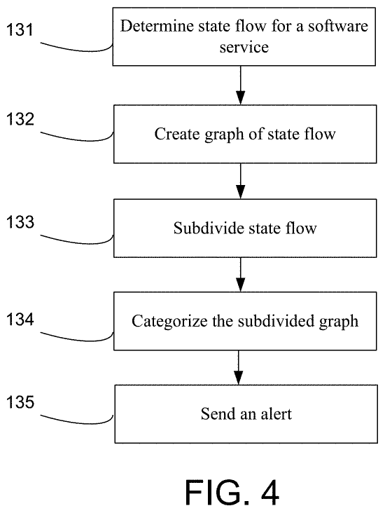

FIG. 4 illustrates an exemplary method for dynamically assessing user experience and security anomalies. At step 131, a state flow for a software service is determined. At step 132, a graph of the state flow may be created. The graph may include a start state node, an end state node, a plurality of intermediary state nodes, and a plurality of state transitions. At step 133, subdividing the graph of step 132 into a plurality of graphs in which each graph includes start node 101, end state node 105, at least one of the intermediary state nodes (e.g., VPN_Pass_Authentication node 102, VPN_Failed_Attempt node 103, or VPN_Session_Active node 104), and at least one of the state transitions. At step 134, categorizing the subdivided graphs of step 133 based on device or statistical information. At step 135, sending an alert which may be based on the category of the subdivided graph. Machine learning may be used to further adjust the state flows and their categories.

This process can be generalized to apply on any application or a service with multi-steps. It can work side by side with survey-based methods so that companies can quickly identify whether their products have problems, what the problems are, and eventually improve customer service by fixing issues before a user reports it. The disclosed system may identify state flows that may lead to a negative user experience for individual users as well as a user group. Conventionally, if a user dropped a call, for example, there is usually just an identification that a call was dropped. But the disclosed system may identify that a call was dropped and also where in the state flow there is a state or state transition that is likely leading to a negative experience. So, there is a more targeted identification of the problem and may lead to more targeted questionnaire questions that confirm or narrow down causes of errors or anomalies (e.g., change in operating system or application version in a user or core network device). Further, the disclosed system may continue to evolve and automatically and dynamically log new states and state transitions.

It is contemplated that the problems detected by the disclosed process can also be security related anomalies that need immediate attention from security analysts to take action. Different than volumetric or signature-based security tools, this analysis is focused on a multi-step process and the relationship among these steps. Different than social network-based graph analysis, the disclosed subject matter allows for even the process representation to be a graph and look into a high-level relationship between nodes and their path, rather than which nodes are more important, which is what another network analysis may perform.

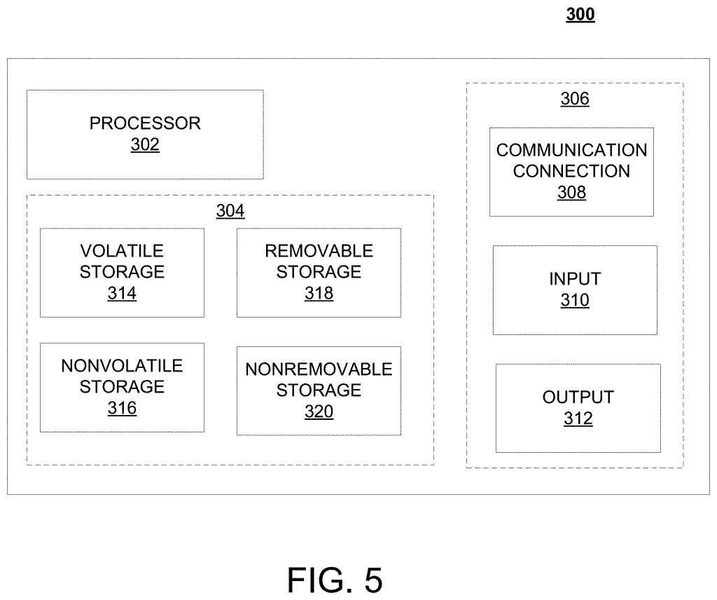

FIG. 5 is a block diagram of network device 300 that may be connected to or comprise a component of system 120. Network device 300 may comprise hardware or a combination of hardware and software. The functionality to facilitate telecommunications via a telecommunications network may reside in one or combination of network devices 300. Network device 300 depicted in FIG. 5 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 5 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength.

In addition to processor 302 and memory 304, network device 300 may include an input/output system 306. Processor 302, memory 304, and input/output system 306 may be coupled together (coupling not shown in FIG. 5) to allow communications between them. Each portion of network device 300 may comprise circuitry for performing functions associated with each respective portion. Thus, each portion may comprise hardware, or a combination of hardware and software. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

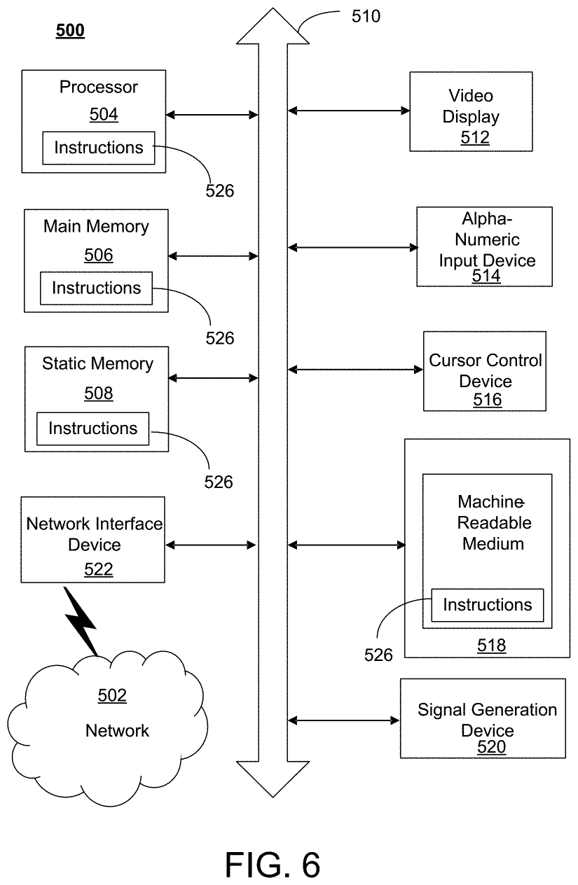

FIG. 6 depicts an exemplary diagrammatic representation of a machine in the form of a computer system 500 within which a set of instructions, when executed, may cause the machine to perform any one or more of the methods described above. One or more instances of the machine can operate, for example, as processor 302, device 121, device 122, and other devices of FIG. XX1. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

As described herein, a telecommunications system may utilize a software defined network (SDN). SDN and a simple IP may be based, at least in part, on user equipment, that provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a system in which dynamically assessing user experience and security anomalies alerts can be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes a device for implementing telecommunications as described herein. When implemented on a general-purpose processor, the program code combines with the processor to provide a unique device that operates to invoke the functionality of a telecommunications system.

While the disclosed systems have been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—dynamically assessing user experience and security anomalies—as illustrated in the Figures, specific terminology is employed for the sake of clarity. The claimed subject matter, however, is not intended to be limited to the specific terminology so selected. In addition, the use of the word “or” is generally used inclusively unless otherwise provided herein. It is contemplated that the method steps herein (e.g., FIG. 3 and FIG. 4) may conducted on one device or distributed over multiple devices.

This written description uses examples to enable any person skilled in the art to practice the claimed subject matter, including making and using any devices or systems and performing any incorporated methods. Other variations of the examples are contemplated herein.

Methods, systems, and apparatuses, among other things, as described herein may provide for determining a plurality of state flows for a software service, wherein the plurality of state flows comprises a first state flow and a second state flow; determining a plurality of sessions for the software service, wherein the plurality of sessions comprise a first group of sessions that executed the first state flow and a second group of sessions that executed the second state flow; receiving statistical information regarding the plurality of state flows and the plurality of sessions for the software service; sending, based on the statistical information, an indication that the second state flow is likely causing a negative user experience; and in response to the indication that the second state flow is likely causing the negative user experience, sending an alert to a user profile associated with a session of the second group of sessions, wherein the alert comprises a questionnaire about the user experience of the software service. The method may provide for determining that the plurality of sessions are associated with at least one of the plurality of state flows, one or more sessions are associated with each state flow of the plurality of state flows and one or more user profiles are associated with each session of the one or more sessions. The method, system, computer readable storage medium, or apparatus provides for receiving a response to the alert, the response are answers from a user associated with a received questionnaire about the user experience of the software service; and categorizing the second state flow based on the response to the alert. Each of the plurality of state flows are categorized in relation to a range of user experiences, such as a rating of between 0 (worst experience) and 100 (best experience). The device information may include virtual computer processing unit (vCPU), a network interface card (NIC), and computer memory. All combinations in this paragraph (including the removal or addition of steps) are contemplated in a manner that is consistent with the other portions of the detailed description.

1. A method comprising:
determining, by a processing system including a processor, a plurality of state flows according to a graph of a software service, the graph comprising nodes interconnected by edges, the nodes corresponding to states of the software service and the edges corresponding to transitions between the nodes, wherein the plurality of state flows comprises a first state flow and a second state flow, the first state flow comprises a first group of nodes interconnected by a first group of edges and the second state flow comprises a second group of nodes interconnected by a second group of edges;
determining, by the processing system, a plurality of sessions for the software service, wherein the plurality of sessions comprise a first group of sessions that executed the first state flow and a second group of sessions that executed the second state flow;
receiving, by the processing system, information regarding the plurality of state flows and the plurality of sessions for the software service;
sending, by the processing system and based on the information, an indication that the second state flow is likely causing a negative user experience; and
in response to the indication that the second state flow is likely causing the negative user experience, sending, by the processing system, an alert to a user profile associated with a session of the second group of sessions.

2. The method of claim 1, wherein the alert comprises a questionnaire about the negative user experience of the software service.

3. The method of claim 1, further comprising:
receiving, by the processing system, a response to the alert, the response are answers from a user associated with a received questionnaire about the negative user experience of the software service; and
categorizing, by the processing system, the second state flow based on the response to the alert.

4. The method of claim 1, wherein each of the plurality of state flows are categorized in relation to a range of user experiences.

5. The method of claim 1, wherein the information is statistical information.

6. The method of claim 1, wherein the information is device information.

7. The method of claim 1, wherein the software service is a virtual private network service.

8. An apparatus comprising:
a processing system including a processor; and
a memory that stores executable instructions that, when executed by the processing system, facilitate performance of operations, the operations comprising:
determining a plurality of state flows according to a graph of a software service, the graph comprising nodes interconnected by edges, the nodes corresponding to states of the software service and the edges corresponding to transitions between the nodes, wherein the plurality of state flows comprises a first state flow and a second state flow, the first state flow comprises a first group of nodes interconnected by a first group of edges and the second state flow comprises a second group of nodes interconnected by a second group of edges;
determining a plurality of sessions for the software service, wherein the plurality of sessions comprise a first group of sessions that executed the first state flow and a second group of sessions that executed the second state flow;
receiving information regarding the plurality of state flows and the plurality of sessions for the software service;
sending, based on the information, an indication that the second state flow is likely causing a negative user experience; and
in response to the indication that the second state flow is likely causing the negative user experience, sending an alert to a user profile associated with a session of the second group of sessions.

9. The apparatus of claim 8, wherein the alert comprises a questionnaire about the negative user experience of the software service.

10. The apparatus of claim 8, the operations further comprising:
receiving a response to the alert, the response are answers from a user associated with a received questionnaire about the negative user experience of the software service; and
categorizing the second state flow based on the response to the alert.

11. The apparatus of claim 8, wherein each of the plurality of state flows are categorized in relation to a range of user experiences.

12. The apparatus of claim 8, wherein the information is statistical information.

13. The apparatus of claim 8, wherein the information is device information.

14. The apparatus of claim 8, wherein the software service is a virtual private network service.

15. A non-transitory, computer readable storage medium storing computer executable instructions that when executed by a processing system including a processor, facilitate performance of operations, the operations comprising:
determining a plurality of state flows according to a graph of a software service, the graph comprising nodes interconnected by edges, the nodes corresponding to states of the software service and the edges corresponding to transitions between the nodes, wherein the plurality of state flows comprises a first state flow and a second state flow, the first state flow comprises a first group of nodes interconnected by a first group of edges and the second state flow comprises a second group of nodes interconnected by a second group of edges;
determining a plurality of sessions for the software service, wherein the plurality of sessions comprise a first group of sessions that executed the first state flow and a second group of sessions that executed the second state flow;
receiving information regarding the plurality of state flows and the plurality of sessions for the software service;
sending, based on the information, an indication that the second state flow is likely causing a negative user experience; and
in response to the indication that the second state flow is likely causing the negative user experience, sending an alert to a user profile associated with a session of the second group of sessions.

16. The non-transitory, computer readable storage medium of claim 15, wherein the alert comprises a questionnaire about the negative user experience of the software service.

17. The non-transitory, computer readable storage medium of claim 15, further comprising:
receiving a response to the alert, the response are answers from a user associated with a received questionnaire about the negative user experience of the software service; and
categorizing the second state flow based on the response to the alert.

18. The non-transitory, computer readable storage medium of claim 15, wherein each of the plurality of state flows are categorized in relation to a range of user experiences.

19. The non-transitory, computer readable storage medium of claim 15, wherein the information is statistical information.

20. The non-transitory, computer readable storage medium of claim 15, wherein the information is device information.
